(19) United States
(12) Patent Application Publication
(10) Pub. No.: US 2023/0219735 A1
(43) Pub. Date: Jul. 13, 2023

(54) DISPENSING CONTAINER

(71) Applicant: Krechona NGOMBA-WESTBROOK, Vallejo, CA (US)

(72) Inventor: Krechona NGOMBA-WESTBROOK, Vallejo, CA (US)

(21) Appl. No.: 17/860,114

(22) Filed: Jul. 8, 2022

Related U.S. Application Data
(60) Provisional application No. 63/297,699, filed on Jan. 8, 2022.

(51) Int. Cl. B65D 83/00

(52) U.S. Cl. CPC B65D 83/0022

(57) ABSTRACT

A dispensing container comprising a container, wherein the container includes a bottom with a concave area that allows a content of the container to converge towards a center of the concave area, a top, and a wall extending from the bottom towards the top, wherein a tube extends from the top to the concave area to extract the contents of the container out the top of the container.

### FIELD OF THE INVENTION

The present technology is in the field of containers, and more precisely, containers for fluid, semi-fluid, and high viscosity fluid substances.

### BACKGROUND

Containers have been used for thousands of years for various purposes. A container may be used for storage, transport, and/or holding a variety of substances. Containers are commonly used to store, transport, and/or hold fluid substances, such as liquids and other viscous substances. The containers may have various shapes and sizes. In addition, containers may also be sealed and pressurized with various gases to force its contents up a tube and out the top when a valve near the top is opened by the user. Alternatively containers may have a manual pump at its top that can be operated by the user to create a negative pressure to extract the contents up a tube and out through the manual pump.

Flat, convex, and moderately concave bottom conventional containers store their contents in a way that does not allow them to pool in a concentrated place for complete extraction. The tube that extends from the top of the container to the bottom of the container is not able to fully extract all the contents of a conventional container.

To retrieve all the contents in a conventional container, users have to either cut the container open, heat it up so that the contents become fluid enough to be poured out, extend and/or move the extraction tube in an attempt to extract more of the container's contents from the bottom, combine the contents of multiple containers of the same product, heating up water to boiling temperature and then use that same water to dilute the product so that it becomes fluid and hot enough to retrieve from the bottle, or a combination thereof. Users often struggle to retrieve all of the contents of a container that comprises a product that they purchased.

There is a need to prevent unsatisfactory waste of a container's contents and to promote full extraction of its contents. According to a consumer organization's research, “as much as 25 percent of the stuff we paid for could have easily been tossed in the trash.” This means the remaining contents of a conventional container may be as much as 25% and are wasted and thrown away by sheer virtue of inaccessibility.

Therefore, what is needed is a solution for both the storage of contents in a container and the full/maximum extraction of that content by a manual pump (or pressure) from within the container.

### SUMMARY OF THE INVENTION

In accordance with various embodiments and aspects of the invention, the disclosed dispensing container enables the full/maximum extraction of its contents with a manual pump (or pressure) from within the container.

As can be seen in FIG. 1, in accordance with some embodiments of the invention, a dispensing container includes a bottom with a concave area that allows a content of the container to converge towards the center of the concave area. The dispensing container has walls that extend form the bottom towards the top of the container. The container may be provided with an extracting device. The extracting device may be in the form of a manual pump at the top of the container with a tube that extends to the center of the concave area at the bottom. Alternatively, the dispensing container may be pressurized and sealed with a content extracting device in the form of a valve at the top of the container with a tube extending from the valve at the top to the center of the concave area at the bottom to extract the contents of the container out the top of the container.

### BRIEF DESCRIPTION OF THE DRAWINGS

In order to understand the invention more fully, a reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1A shows one embodiment of a dispensing container.

FIG. 1B shows one embodiment of a dispensing container.

FIG. 2A shows the dispensing container of FIG. 1A.

FIG. 2B shows the dispensing container of FIG. 1B.

FIG. 3A shows the top view of the dispensing container of FIG. 1A.

FIG. 3B shows the top view of the dispensing container of FIG. 1B.

FIG. 4 shows various embodiments of the bottom of various dispensing containers with different angles.

FIG. 5A shows various views of alternative embodiments of dispensing containers with various shapes and sizes.

FIG. 5B shows various views of alternative embodiments of dispensing containers with various shapes and sizes.

FIG. 5C shows various views of alternative embodiments of dispensing containers with various shapes and sizes.

FIG. 6A shows the various views of alternative embodiments of dispensing containers with various shapes and sizes.

FIG. 6B shows the various views of alternative embodiments of dispensing containers with various shapes and sizes.

### DETAILED DESCRIPTION

The following describes various aspects and embodiments of the invention. Generally, examples can use the described aspects in any combination. All statements herein reciting principles, aspects, and embodiments, as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure. To the extent that the terms “including”, “includes,” “having”, “has”, “with”, or variants thereof are used in either the detailed description and the claims, such terms are intended to be inclusive in a similar manner to the term “comprising”.

Reference throughout this specification to “one embodiment,” “an embodiment,” or “in accordance with some aspects” and similar language means that a particular feature, structure, or characteristic described in connection with the various aspects and embodiments are included in at least one embodiment of the invention. Thus, appearances of the phrases “in accordance with an aspect,” “in accordance with one embodiment,” “in an embodiment,” “in certain embodiments,” and similar language throughout this specification refer to the various features of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

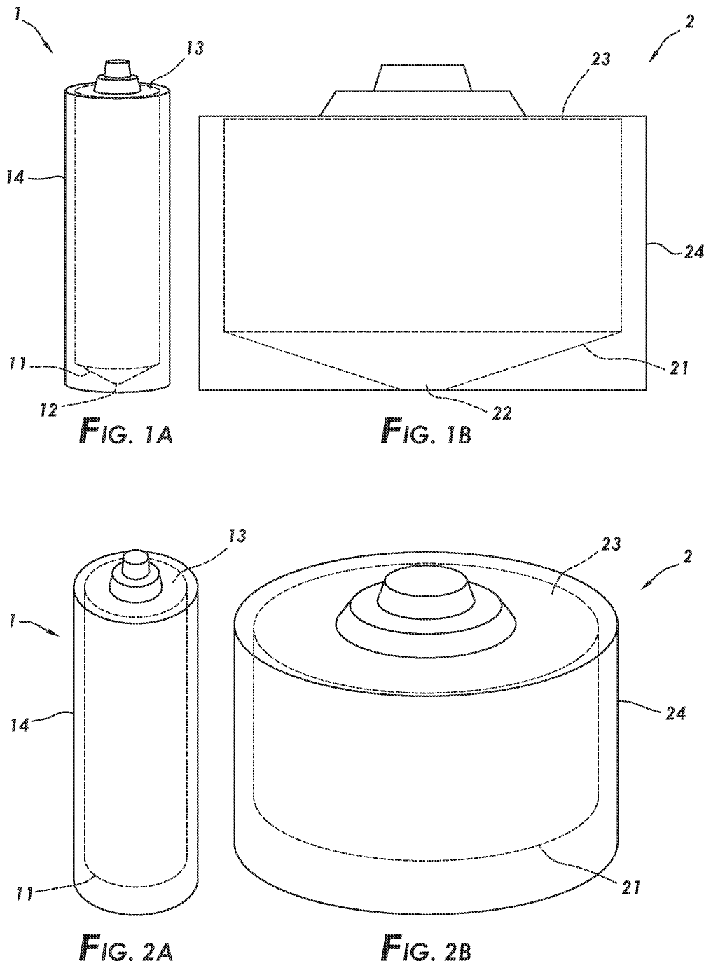

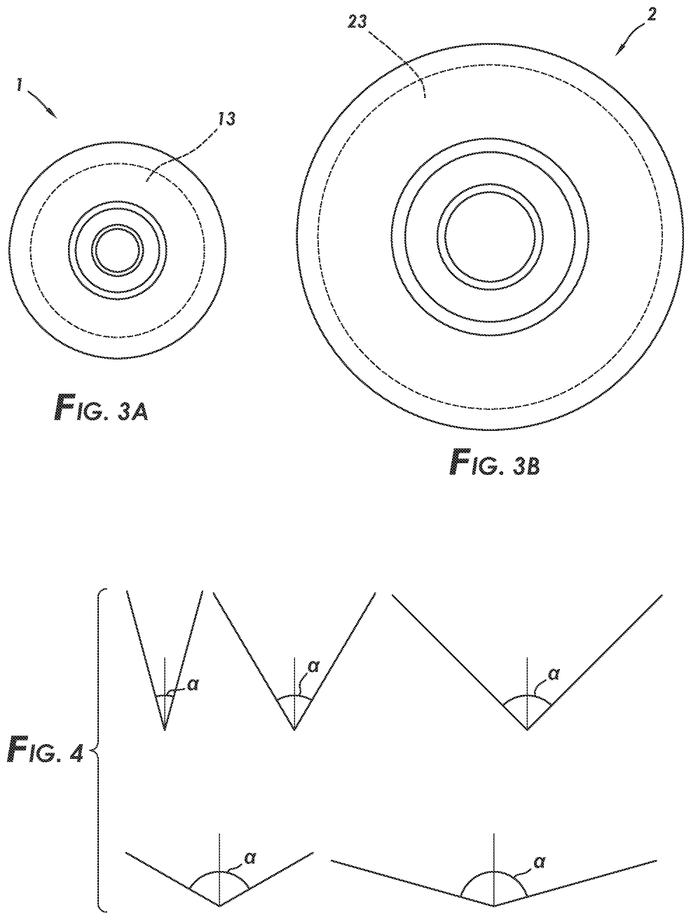

Referring to FIG. 1A, 1B, 2A, 2B, 3A, and 3B, the dispensing container 1, 2 is shown and includes a bottom 11, 21, respectively, in accordance with the various embodiments of the invention. The bottom 11,21 includes a concave area 12, 22, respectively, that allows a content of the dispensing container 1, 2 to converge towards the bottom and center of the concave area 12, 22. The dispensing container 1,2 includes a top 13, 23, respectively. The dispensing container 1,2 includes a wall 14, 24, respectively. The wall 14, 24 has an inner surface and an outer surface. The wall 14, 24 extends from the bottom towards the top 13, 23, wherein a content extracting device may be in the form of a tube extending from the top 13, 23 to the concave area 12, 22 to extract the contents of the dispensing container 1, 2 out the top 13, 23 of the dispensing container 1, 2.

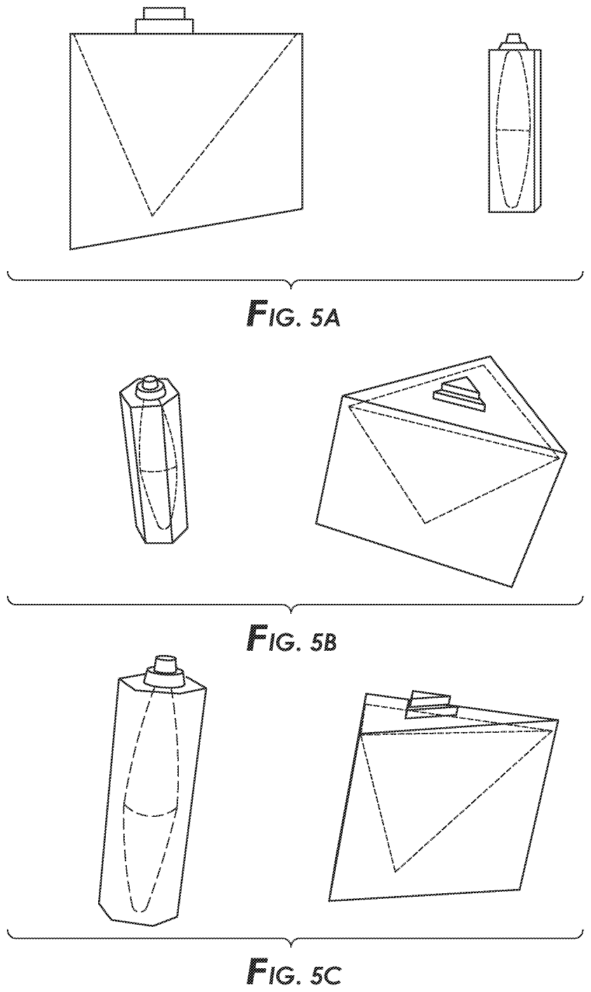

The concave area would form the lowest area at the bottom of and/or the bottom of the inside of the dispensing container. The lowest area is an area of sufficient smallness and is a location where the content collects (under gravity forces) in order to enable maximum content extraction. The content of the container may be a fluid, a semi-fluid, low viscosity fluid, or a high viscosity fluid. FIG. 4 shows that the bottom of the dispensing container may be formed at different angles, from acute angles to obtuse angles.

The dispensing container may be provided with a content extracting device in the form of a manual pump, which is positioned or placed at the top of the dispensing container. In accordance with some embodiment of the invention, the manual pump includes a tube that extends to the center of the concave area at the bottom (lowest location) of the dispensing container. Upon operation of the manual pump, such as by pressing down on the manual pump, a negative pressure is created in the tube that will extract the contents of the dispensing container through the tube and out the top of the dispensing container.

Alternatively, the dispensing container may be pressurized and sealed with a content extracting device in the form of a valve at the top with a tube extending from the valve at the top to the center of the concave area at the bottom to extract the contents of the dispensing container out the top of the dispensing container. Upon operation of the valve, the pressurized gas/air in the dispensing container will force the contents of the dispensing container up through the tube and out the top of the dispensing container.

In accordance with the various aspects and embodiments of the invention, the content extracting device is a device for extracting the content of the dispensing container and may be a tube with a pump at one end, a tube with a plunger end, or an eye dropper with a plunger end.

The dispensing container may be formed from any material including clay, ceramics, glass, rubber, or any other suitable materials.

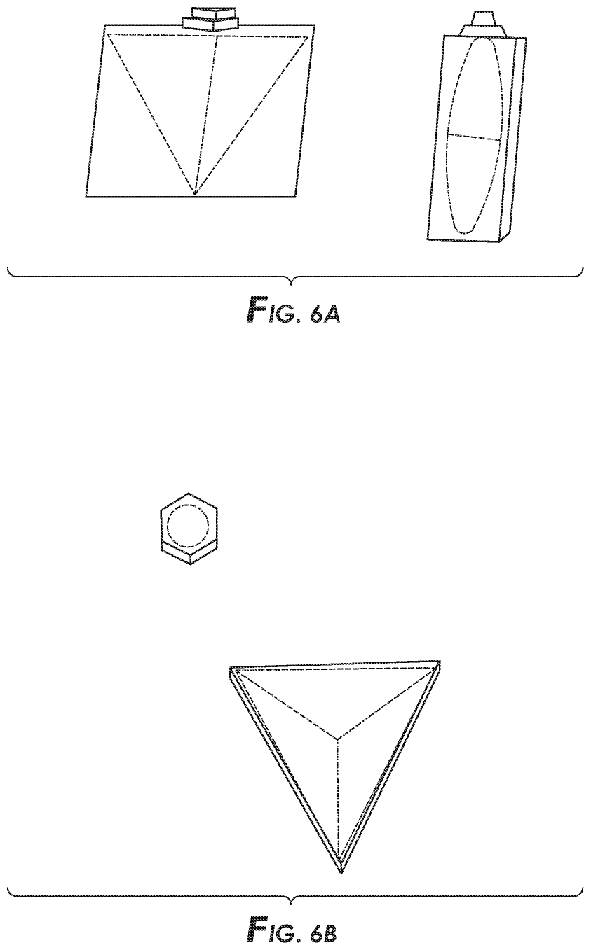

As shown in FIG. 5A, FIG. 5B, FIG. 5C, FIG. 6A, and FIG. 6B, in accordance with the various aspects and embodiments of the invention, the dispensing container has various shapes and sizes. The dispensing container may include any three-dimensional shape. The dispensing container includes walls that may generally be in the form of a cylinder, or an elliptical wall. Alternatively and in accordance with the various aspects and embodiments of the invention, the dispensing container may have walls that form a polygon around a circumference of the bottom and/or top. Furthermore and in accordance with the various aspects and embodiments of the invention, the dispensing container may have walls that expand outward from the bottom, away from a center axis of the dispensing container and then contracts inward towards the center axis of the dispensing container near the top, with a larger circumference formed anywhere between the top and the bottom. In addition and in accordance with the various aspects and embodiments of the invention, the dispensing container may take the form of a rectangular prism or any other three-dimensional (3D) geometrical shape that tapers on the inside to an area of sufficient smallness from where the content is extracted.

In accordance with the various aspects and embodiments of the invention, the dispensing container is supported with a stand that will maintain the container in an upright position. The stand may include a stable base that would securely support the dispensing container in the upright position, such as those shown in FIG. 5A, FIG. 5B, FIG. 5C, FIG. 6A, and FIG. 6B. In accordance with the various aspects and embodiments of the invention, in addition to the wide stable base, the stand may take the shape of the dispensing container to securely hold and maintain the upright position of the dispensing container. Alternatively, in addition to the wide stable base, the stand may support the container near its largest circumference, thereby securely holding and maintaining the upright position of the container.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

The benefit of this invention is that it enables the user to fully extract the contents of the container. Therefore, the scope of the invention is not intended to be limited to the various aspects and embodiments discussed and described herein. Rather, the scope and spirit of invention is embodied by the appended claims.

What is claimed is:

1. A dispensing container comprising:
a container, wherein the container includes:
a bottom with a concave area that allows a content of the container to converge towards a center of the concave area;
a top; and
a wall extending from the bottom towards the top,
wherein a content extracting device is provided to extract the contents of the container out the top.

2. The dispensing container of claim 1, wherein the content extracting device may be alternatively, a tube with a pump at one end, a tube with a plunger end, or an eye dropper with a plunger end.

3. The dispensing container of claim 1, wherein the container is pressurized to force the contents of the container through a tube and out the top of the container.

4. The dispensing container of claim 3, wherein a valve is connected to the top of the container.

5. The dispensing container of claim 1, wherein the wall is cylindrical, spherical, or any other three-dimensional shape.

6. The dispensing container of claim 1, wherein the wall is elliptical, circular, triangular, or any other shape.

7. The dispensing container of claim 1, wherein the wall forms a polygon around a circumference of the bottom.

8. The dispensing container of claim 1, wherein the wall expands outward from the bottom away from a center axis of the container and then contracts inward towards the center axis of the container near the top.

9. The dispensing container of claim 1, wherein the container is supported with a stand that will maintain the container in an upright position.

10. A dispensing container comprising:
a container, wherein the container includes:
a bottom that converges to a lowest area in the container that allows a content of the container to converge towards the lowest area in the container;
a top; and
a wall extending from the bottom towards the top,
wherein a tube extends from the top to the lowest area in the container to extract the contents of the container out the top of the container.

11. The dispensing container of claim 10, wherein a pump is connected to the tube at the top of the container to extract the contents of the container.

12. The dispensing container of claim 10, wherein the container is pressurized to force the contents of the container through the tube and out the top of the container.

13. The dispensing container of claim 12, wherein a valve is connected to the top of the container.

14. The dispensing container of claim 10, wherein the wall is cylindrical, spherical, or any other three-dimensional shape.

15. The dispensing container of claim 10, wherein the wall is elliptical, circular, triangular, or any other shape.

16. The dispensing container of claim 10, wherein the wall forms a polygon around a circumference of the bottom.

17. The dispensing container of claim 10, wherein the wall expands outward from the bottom away from a center axis of the container and then contracts inward towards the center axis of the container near the top.

18. The dispensing container of claim 10, wherein the wall takes the form of a rectangular prism or a three-dimensional geometrical shape that tapers on the inside to an area of sufficient smallness from where the content is extracted.

19. The dispensing container of claim 10, wherein the container is supported with a stand that will maintain the container in an upright position.

20. A dispensing container comprising:
a container, wherein the container includes:
a bottom with a concave area that allows a content of the container to converge towards a center of the concave area;
a top with a manual pump;
a wall extending from the bottom towards the top; and
a stand that will maintain the container in an upright position,
wherein a tube extends from the manual pump to the concave area to extract the contents of the container out the top of the container.
